(19) United States
(12) Patent Application Publication
(10) Pub. No.: US 2012/0173260 A1
(43) Pub. Date: Jul. 5, 2012

(54) SYSTEMS AND METHODS FOR WORKFLOW AUTOMATION FOR MDT REFERRAL

(75) Inventors: Gauri Pandurang Nayak, Bangalore (IN); Himanshu Singh, Bangalore (IN); Arun Semalaiappan, Bangalore (IN)

(73) Assignee: General Electric Company, Schenectady, NY (US)

(21) Appl. No.: 13/049,601

(22) Filed: Mar. 16, 2011

(30) Foreign Application Priority Data
Dec. 29, 2010 (IN) 4002/CHE/2010

(51) Int. Cl. G06Q 50/00; G06Q 10/00

(52) U.S. Cl. 705/2

(57) ABSTRACT

Certain examples provide systems, methods, and apparatus for multidisciplinary team review of a referred patient. Certain examples provide a multidisciplinary team patient referral system. The system includes a user interface to facilitate user selection of a patient for multidisciplinary review. The system includes a subscription service to generate a subscription for a user to automatically notify the user of multidisciplinary team events related to the patient based on a parameter of the subscription. The system includes a multidisciplinary meeting module to facilitate a multidisciplinary team review of the patient to develop an evaluation for the patient.

### RELATED APPLICATION

This patent claims the benefit of priority of Indian Patent Application No. 4002/CHE/2010, filed on Dec. 29, 2010, which is hereby incorporated herein in its entirety.

### FIELD

The present invention generally relates to multidisciplinary team review of a patient condition. In particular, the present invention relates to systems, methods, and apparatus for automating a multidisciplinary team workflow to review a patient, notify one or more interested users, and generate a result.

### BACKGROUND

A healthcare environment, such as a hospital or clinic, encompasses a large array of professionals, patients, equipment and computerized information systems. Healthcare environments, such as hospitals or clinics, include information systems, such as healthcare information systems (HIS), radiology information systems (RIS), clinical information systems (CIS), and cardiovascular information systems (CVIS), and storage systems, such as picture archiving and communication systems (PACS), library information systems (LIS), and electronic medical records (EMR). Information stored may include patient medical histories, imaging data, test results, diagnosis information, management information, and/or scheduling information, for example. The information for a particular information system may be centrally stored or divided at a plurality of locations. Healthcare practitioners may desire to access patient information or other information at various points in a healthcare workflow. Different clinical departments and different clinical systems gather patient information in different ways and in different forms and often separately store that information.

### BRIEF SUMMARY

Certain examples provide systems, methods, and apparatus for multidisciplinary team review of a referred patient.

Certain examples provide a multidisciplinary team patient referral system. The system includes a user interface to facilitate user selection of a patient for multidisciplinary review. The system includes a subscription service to generate a subscription for a user to automatically notify the user of multidisciplinary team events related to the patient based on a parameter of the subscription. The system includes a multidisciplinary meeting module to facilitate a multidisciplinary team review of the patient to develop an evaluation for the patient.

Certain examples provide a tangible computer readable storage medium including executable program instructions which, when executed by a computer processor, cause the computer to implement a multidisciplinary team patient referral system. The system includes a user interface to facilitate user selection of a patient for multidisciplinary review. The system includes a subscription service to generate a subscription for a user to automatically notify the user of multidisciplinary team events related to the patient based on a parameter of the subscription. The system includes a multidisciplinary meeting module to facilitate a multidisciplinary team review of the patient to develop an evaluation for the patient.

Certain examples provide a computer-implemented method for a multidisciplinary team patient review. The method includes accepting user selection of a patient for multidisciplinary review. The method includes generating a subscription for a user to automatically notify the user of multidisciplinary team events related to the patient based on a parameter of the subscription. The method includes automatically scheduling a multidisciplinary team review of the patient for a multidisciplinary team administrator. The method includes facilitating a multidisciplinary team review of the patient to develop an evaluation for the patient.

### BRIEF DESCRIPTION OF SEVERAL VIEWS OF THE DRAWINGS

FIG. 1 depicts a flow diagram for an example method for facilitating a multidisciplinary team (MDT) referral process.

FIG. 2 illustrates an example MDT referral system.

FIG. 3 shows a block diagram of an example clinical information system capable of implementing the example methods and systems described herein.

FIG. 4 is a block diagram of an example processor system that may be used to implement systems, apparatus, and methods described herein.

The foregoing summary, as well as the following detailed description of certain embodiments of the present invention, will be better understood when read in conjunction with the appended drawings. For the purpose of illustrating the invention, certain embodiments are shown in the drawings. It should be understood, however, that the present invention is not limited to the arrangements and instrumentality shown in the attached drawings.

### DETAILED DESCRIPTION OF CERTAIN EXAMPLES

Although the following discloses example methods, systems, articles of manufacture, and apparatus including, among other components, software executed on hardware, it should be noted that such methods and apparatus are merely illustrative and should not be considered as limiting. For example, it is contemplated that any or all of these hardware and software components could be embodied exclusively in hardware, exclusively in software, exclusively in firmware, or in any combination of hardware, software, and/or firmware. Accordingly, while the following describes example methods, systems, articles of manufacture, and apparatus, the examples provided are not the only way to implement such methods, systems, articles of manufacture, and apparatus.

When any of the appended claims are read to cover a purely software and/or firmware implementation, in an embodiment, at least one of the elements is hereby expressly defined to include a tangible medium such as a memory, DVD, CD, Blu-ray, etc., storing the software and/or firmware.

Certain examples provide systems, apparatus, and methods to facilitate a workflow for automating a multi-disciplinary team (MDT) referral process. The MDT referral process helps reduce or remove manual intervention, reduce turn-around time and improve the customer experience by providing precise care.

A current MDT referral process requires an MDT Admin to manually gather MDT referred cases, process them, and send the MDT outcome to the concerned attending physician manually. Using this manual process, human error may be introduced, leading to unsatisfactory patient care.

Certain examples provide automated initiation, notification, and facilitation of a workflow for MDT referral and review. Certain examples facilitate MDT referral using a subscription service. The subscription service facilitates notification of an administrator and/or other user (e.g., an attending physician) via a plurality of subscriptions. For example, three different types of subscriptions can be used to facilitate MDT referrals: 1) a MDT referral request from an attending physician to the MDT administrator; 2) a MDT referral response from the MDT administrator to the attending physician; and 3) a MDT evaluation report availability notification from the MDT administrator to the attending physician.

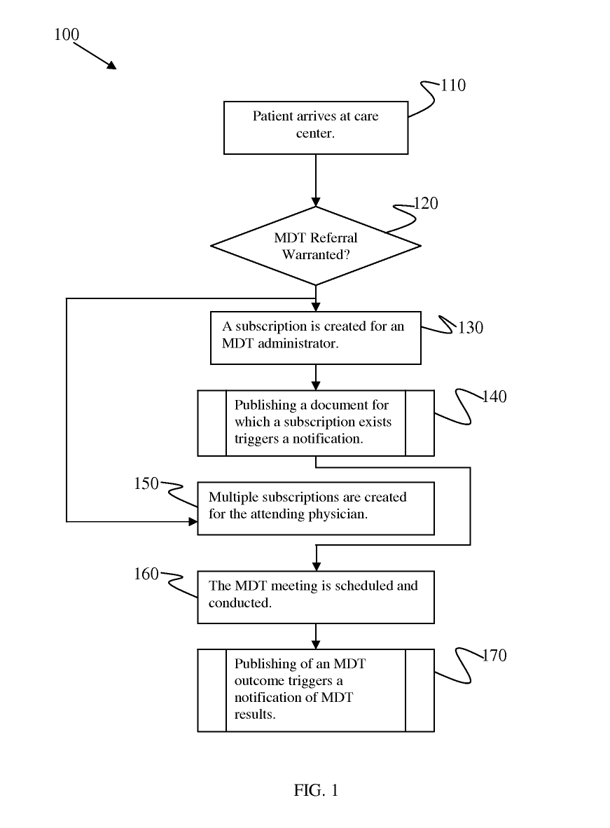

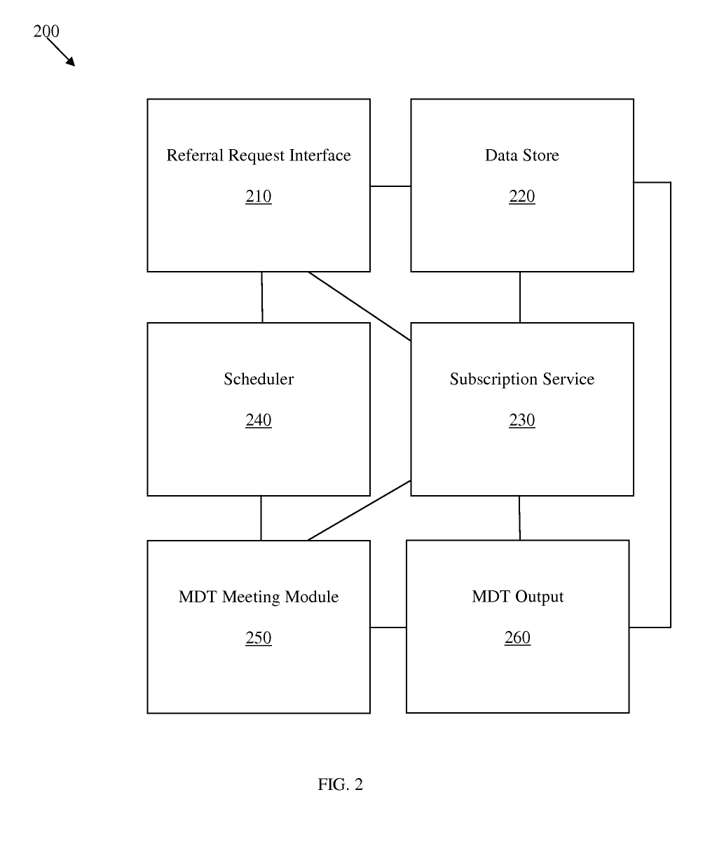

FIG. 1 is a flow diagram representative of example machine readable instructions that can be executed to implement the example systems shown in FIG. 2 and/or portions of one or more of those systems. The example process(es) of FIG. 1 can be performed using a processor, a controller and/or any other suitable processing device. For example, the example process(es) of FIG. 1 can be implemented using coded instructions (e.g., computer readable instructions) stored on a tangible computer readable medium such as a flash memory, a read-only memory (ROM), and/or a random-access memory (RAM). As used herein, the term tangible computer readable medium is expressly defined to include any type of computer readable storage and to exclude propagating signals. Additionally or alternatively, the example process(es) of FIG. 1 can be implemented using coded instructions (e.g., computer readable instructions) stored on a non-transitory computer readable medium such as a flash memory, a read-only memory (ROM), a random-access memory (RAM), a cache, or any other storage media in which information is stored for any duration (e.g., for extended time periods, permanently, brief instances, for temporarily buffering, and/or for caching of the information). As used herein, the term non-transitory computer readable medium is expressly defined to include any type of computer readable medium and to exclude propagating signals.

Alternatively, some or all of the example process(es) of FIG. 1 can be implemented using any combination(s) of application specific integrated circuit(s) (ASIC(s)), programmable logic device(s) (PLD(s)), field programmable logic device(s) (FPLD(s)), discrete logic, hardware, firmware, etc. Also, some or all of the example process(es) of FIG. 1 can be implemented manually or as any combination(s) of any of the foregoing techniques, for example, any combination of firmware, software, discrete logic and/or hardware. Further, although the example process(es) of FIG. 1 is described with reference to the flow diagram of FIG. 1, other methods of implementing the process(es) of FIG. 1 can be employed. For example, the order of execution of the blocks can be changed, and/or some of the blocks described can be changed, eliminated, sub-divided, or combined. Additionally, any or all of the example process(es) of FIG. 1 can be performed sequentially and/or in parallel by, for example, separate processing threads, processors, devices, discrete logic, circuits, etc.

FIG. 1 depicts a flow diagram for an example method 100 for facilitating a multidisciplinary team (MDT) referral process. At block 110, a patient arrives at a provider care facility. For example, a patient arrives at a primary care center with a primary care physician. At block 120, an attending physician determines whether the patient should receive an MDT referral. For example, the physician identifies the patient's case to be one on which a multidisciplinary team should work. For example, an admission-discharge-transfer (ADT) screen and/or a MDT worklist is used to evaluate the patient to identify a case for an MDT.

At block 130, the attending physician triggers an action to create a subscription for an MDT administrator. For example, the physician can check and/or otherwise select a box, button, dropdown/combo box, etc., to create a subscription for the MDT administrator. The subscription is to internally generate and submit a synthetic document identifying the MDT subscription with respect to the patient. The synthetic or “dummy” document does not include patient data but rather describes the requested subscription, for example. For example, the MDT referral request subscription from the attending physician to the MDT administrator can include author (e.g., attending physician) information, a class code identifying the MDT referral request (e.g., a document identifier), and patient identification.

At block 140, upon creation of the subscription, the synthetic MDT document is published to a registry/repository. Publishing the MDT document triggers a notification for the MDT administrator. For example, the MDT document is used to create a subscription on behalf of MDT administrator. If further information regarding this patient is provided and/or otherwise made available, the MDT administrator will be made aware of it via the subscription and the registry/repository. When any document of interest arrives for this particular patient, the MDT administrator is automatically notified, for example.

The notification can facilitate the MDT administrator's workflow in a variety of ways. For example, notification can list the patients who have been referred for MDT discussion. Notification can provide a one-point access to each patient's documents, for example.

At block 150, multiple subscriptions are created for the attending physician. For example, one subscription can alert the physician upon arrival of an MDT outcome, and another subscription can send notifications regarding a status of the MDT process. For example, a subscription is created to alert the attending physician if his/her referral has been accepted, put on hold, has been cancelled, etc. The subscription can be implemented as an SMTP-based email notification or a synthetic document-based notification, for example. The notification can include a class code for the MDT referral response (e.g., a document identifier), a status (e.g., approved, rejected, on hold, etc.), a meeting time, a reason/comment related to the referral response, etc.

Another subscription is created to alert the physician regarding the availability of an MDT evaluation. The physician can be notified of the scheduling of the patient for the MDT workflow (e.g., date and time) via the subscription, for example. The physician can be notified of a change in status to this schedule, for example. The subscription can be facilitated using a valid document-based notification including a class code for an MDT evaluation report.

Subscription(s) can relate to any document arriving for a particular patient, can be restricted to particular type of document, particular outcome, and/or other criterion(-ia), for example. A subscription-related document can be implemented as a synthetic or “dummy” document and/or message structure that does not include patient data but rather describes the requested subscription for the recipient, for example. Alternatively or in addition, a subscription-related document can include substantive data regarding the patient and/or MDT process, for example. In certain examples, a subscription “document” can be a pointer, flag, parameter, etc., used to trigger an MDT referral subscription and associated notification(s). In certain examples, an MDT administrator subscription and associated notification(s) and a physician subscription and associated notification(s) can proceed in separate workflows.

In certain examples, a list of alerts is provided to the user's regular email inbox and/or a custom MDT and/or notification inbox. The user (e.g., the physician) can click on and/or otherwise select a patient and review all documents for that patient in one location. The message inbox for the subscription facilitates the MDT administrator's workflow by providing one point access to all of the patient's documents, for example. Subscription-related documents can be made available to all physicians involved in the MDT meeting, for example.

At block 160, the MDT meeting is scheduled and conducted by the MDT administrator. For example, the MDT administrator can be provided with a list of all MDT patients to schedule MDT meeting(s) and evaluations. For example, the MDT administrator can click on and/or otherwise select a link to schedule the meeting. Notification of the meeting is sent to physician(s) involved. The MDT administrator (and attending physician) is notified of accept/decline results from requested participants of the MDT meeting, for example. Meeting results are captured as a clinical summary and/or MDT evaluation report, for example. The summary and/or report are published in the registry/repository, for example.

At block 170, publication of an MDT outcome document triggers a notification alert for the attending physician regarding the availability of the MDT results. Thus, the attending physician does not have to keep polling the administrator but, rather, is notified when the MDT results/outcome document is available. The attending physician can then proceed with the patient's diagnosis and/or treatment workflow.

FIG. 2 illustrates an example MDT referral system 200. The system 200 includes a referral request interface 210, a data store 220, a subscription service 230, a scheduler 240, an MDT meeting module 250, and an MDT output 260. Using the referral request interface 210, a user (e.g., an attending physician, primary physician, nurse, etc.) can input a patient identifier to retrieve a patient's information and request an MDT referral for that patient.

The interface 210 accesses patient information from the data store 220 to help enable the user to determine whether the patient should be referred for an MDT review. If the user, based on manual review of the patient information and/or in conjunction with an automated, rules-based analysis, determines that the patient is an MDT candidate, the interface 210 triggers the subscription service 230. The subscription service 230 generates a subscription for the user (e.g., a physician and/or MDT administrator) with respect to the patient. The subscription is to notify the user when an event occurs with respect to the patient, for example. If further information regarding the patient is made available, the user and/or a MDT administrator is made aware of the information via the subscription and an associated registry and/or repository of data. When a document of interest arrives for the patient, the MDT administrator is automatically notified, for example. The notification can facilitate the MDT administrator's workflow. For example, notification can list the patients who have been referred for MDT discussion. Notification can provide a point of access to each patient's documents, for example.

In certain examples, multiple subscriptions can be created for the user (e.g., the attending physician) via the subscription service 230. For example, when MDT administrator receives a MDT referral request notification, based on the document identifier code, one or more controls (e.g., check box, radio button, combo box, dropdown list, etc.) are made available inside a notification inbox (e.g., an MDT notification inbox and/or general user mailbox) for a particular notification entry. The MDT administrator can use the one or more controls to accept, reject, put on hold, etc., the MDT referral request. Selecting an option triggers a notification to the attending physician, for example.

For example, one subscription can send notifications regarding a status of the MDT process, and another subscription can alert the physician upon arrival of an MDT outcome. For example, a subscription is created to alert the attending physician if his/her referral has been accepted, put on hold, has been cancelled, etc. The response can be facilitated using one or more inputs/controls such as a checkbox, radio button, combo box, dropdown list, etc. Another subscription is created to alert the physician regarding the availability of an MDT evaluation. The physician can be notified of the scheduling of the patient for the MDT workflow (e.g., date and time) via the subscription, for example. The physician can be notified of a change in status to this schedule, for example. Subscription(s) can relate to any document arriving for a particular patient, can be restricted to particular type of document, particular outcome, and/or other criterion(-ia), for example. In certain examples, a subscription is facilitated using a subscription document that is a synthetic or “dummy” document that does not include patient data but rather describes the requested subscription for the recipient.

Thus, in certain examples, three subscriptions are generated to facilitate: 1) a MDT referral request from the attending physician to the MDT administrator; 2) a MDT referral response from the MDT administrator to the attending physician; and 3) a MDT evaluation report availability notification from the MDT administrator to the attending physician. The MDT referral subscription can be provided as a synthetic or placeholder document/pointer including author (e.g., attending physician) information, a document identification class code (e.g., MDT referral request), and patient identification, for example. When the MDT administrator receives a MDT referral request notification, the administrator can be provided with a control, based on the document identifier code, to accept, reject, or put on hold the referral request, for example. Selecting an option triggers a notification to the requesting user (e.g., the attending physician).

The referral response to the requesting user (e.g., the attending physician) can be facilitated using an email-based notification, a synthetic document, etc. The response includes a document identifier class code (e.g., a MDT referral response, a referral status (e.g., approved, rejected, on hold), a meeting time (if applicable), a reason/comment in explanation, etc.). Additionally, the MDT evaluation report availability notification from the MDT administrator to the requesting user (e.g., the attending physician) can be facilitated using a valid document (as opposed to synthetic or dummy placeholder document) that includes, in addition to evaluation report content, a class code indicative of the MDT evaluation report, for example.

In certain examples, the subscription service 230 provides one or more alert to the user's regular email inbox and/or a custom MDT and/or notification inbox (e.g., via the interface 210). The user (e.g., the physician) can click on and/or otherwise select a patient indicator and review all documents for that patient in one location. The message inbox for the subscription facilitates the MDT administrator's workflow by providing one point access to all of the patient's documents, for example. Subscription-related documents can be made available to all physicians involved in the MDT meeting, for example.

The scheduler 240 facilitates scheduling of an MDT review meeting. For example, the MDT administrator can be provided with a list of all MDT patients to schedule MDT meeting(s) and evaluations. For example, the MDT administrator can click on and/or otherwise select a link to schedule the meeting. Notification of the meeting is sent to physician(s) involved. The MDT administrator is notified of accept/decline results from requested participants of the MDT meeting, for example.

The MDT meeting module 250 allows the MDT administrator to conduct the MDT review. Results are captured as a clinical summary and/or MDT evaluation report via the MDT output 260, for example. The summary and/or report are published in a patient and/or MDT registry and/or repository, for example. In certain examples, publication of an MDT outcome document triggers a notification alert for the user regarding the availability of the MDT results. The user (e.g., an attending physician) can then proceed with the patient's diagnosis and/or treatment workflow based on the MDT outcome, for example.

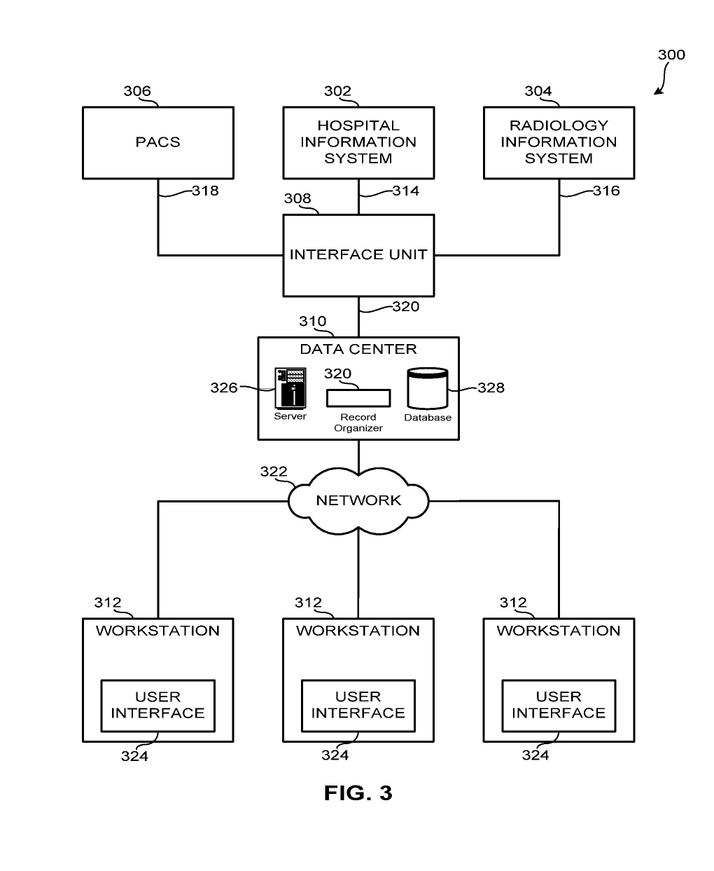

FIG. 3 shows a block diagram of an example clinical information system 300 capable of implementing the example methods and systems described herein. The example clinical information system 300 includes a hospital information system (HIS) 302, a radiology information system (RIS) 304, a picture archiving and communication system (PACS) 306, an interface unit 308, a data center 310, and a plurality of workstations 312. In the illustrated example, the HIS 302, the RIS 304, and the PACS 306 are housed in a healthcare facility and locally archived. However, in other implementations, the HIS 302, the RIS 304, and/or the PACS 306 can be housed at one or more other suitable locations. In certain implementations, one or more of the PACS 306, RIS 304, HIS 302, etc., can be implemented remotely via a thin client and/or downloadable software solution. Furthermore, one or more components of the clinical information system 300 can be combined and/or implemented together. For example, the RIS 304 and/or the PACS 306 can be integrated with the HIS 302; the PACS 306 can be integrated with the RIS 304; and/or the three example information systems 302, 304, and/or 306 can be integrated together. In other example implementations, the clinical information system 300 includes a subset of the illustrated information systems 302, 304, and/or 306. For example, the clinical information system 300 can include only one or two of the HIS 302, the RIS 304, and/or the PACS 306. Information (e.g., scheduling, test results, observations, diagnosis, etc.) can be entered into the HIS 302, the RIS 304, and/or the PACS 306 by healthcare practitioners (e.g., radiologists, physicians, and/or technicians) before and/or after patient examination.

The HIS 302 stores medical information such as clinical reports, patient information, and/or administrative information received from, for example, personnel at a hospital, clinic, and/or a physician's office. The RIS 304 stores information such as, for example, radiology reports, messages, warnings, alerts, patient scheduling information, patient demographic data, patient tracking information, and/or physician and patient status monitors. Additionally, the RIS 304 enables exam order entry (e.g., ordering an x-ray of a patient) and image and film tracking (e.g., tracking identities of one or more people that have checked out a film). In some examples, information in the RIS 304 is formatted according to the HL-7 (Health Level Seven) clinical communication protocol.

The PACS 306 stores medical images (e.g., x-rays, scans, three-dimensional renderings, etc.) as, for example, digital images in a database or registry. In some examples, the medical images are stored in the PACS 306 using the Digital Imaging and Communications in Medicine (“DICOM”) format. Images are stored in the PACS 306 by healthcare practitioners (e.g., imaging technicians, physicians, radiologists) after a medical imaging of a patient and/or are automatically transmitted from medical imaging devices to the PACS 306 for storage. In some examples, the PACS 306 can also include a display device and/or viewing workstation to enable a healthcare practitioner to communicate with the PACS 306.

The interface unit 308 includes a hospital information system interface connection 314, a radiology information system interface connection 316, a PACS interface connection 318, and a data center interface connection 320. The interface unit 308 facilities communication among the HIS 302, the RIS 304, the PACS 306, and/or the data center 310. The interface connections 314, 316, 318, and 320 can be implemented by, for example, a Wide Area Network (“WAN”) such as a private network or the Internet. Accordingly, the interface unit 308 includes one or more communication components such as, for example, an Ethernet device, an asynchronous transfer mode (“ATM”) device, an 802.11 device, a DSL modem, a cable modem, a cellular modem, etc. In turn, the data center 310 communicates with the plurality of workstations 312, via a network 322, implemented at a plurality of locations (e.g., a hospital, clinic, doctor's office, other medical office, or terminal, etc.). The network 322 is implemented by, for example, the Internet, an intranet, a private network, a wired or wireless Local Area Network, and/or a wired or wireless Wide Area Network. In some examples, the interface unit 308 also includes a broker (e.g., a Mitra Imaging's PACS Broker) to allow medical information and medical images to be transmitted together and stored together.

In operation, the interface unit 308 receives images, medical reports, administrative information, and/or other clinical information from the information systems 302, 304, 306 via the interface connections 314, 316, 318. If necessary (e.g., when different formats of the received information are incompatible), the interface unit 308 translates or reformats (e.g., into Structured Query Language (“SQL”) or standard text) the medical information, such as medical reports, to be properly stored at the data center 310. The reformatted medical information can be transmitted using a transmission protocol to enable different medical information to share common identification elements, such as a patient name or social security number. Next, the interface unit 308 transmits the medical information to the data center 310 via the data center interface connection 320. Finally, medical information is stored in the data center 310 in, for example, the DICOM format, which enables medical images and corresponding medical information to be transmitted and stored together.

The medical information is later viewable and easily retrievable at one or more of the workstations 312 (e.g., by their common identification element, such as a patient name or record number). The workstations 312 can be any equipment (e.g., a personal computer) capable of executing software that permits electronic data (e.g., medical reports) and/or electronic medical images (e.g., x-rays, ultrasounds, MRI scans, etc.) to be acquired, stored, or transmitted for viewing and operation. The workstations 312 receive commands and/or other input from a user via, for example, a keyboard, mouse, track ball, microphone, etc. As shown in FIG. 3, the workstations 312 are connected to the network 322 and, thus, can communicate with each other, the data center 310, and/or any other device coupled to the network 322. The workstations 312 are capable of implementing a user interface 324 to enable a healthcare practitioner to interact with the clinical information system 300. For example, in response to a request from a physician, the user interface 324 presents a patient medical history. Additionally, the user interface 324 includes one or more options related to the example methods and apparatus described herein to organize such a medical history using classification and severity parameters.

The example data center 310 of FIG. 3 is an archive to store information such as, for example, images, data, medical reports, and/or, more generally, patient medical records. In addition, the data center 310 can also serve as a central conduit to information located at other sources such as, for example, local archives, hospital information systems/radiology information systems (e.g., the HIS 302 and/or the RIS 304), or medical imaging/storage systems (e.g., the PACS 306 and/or connected imaging modalities). That is, the data center 310 can store links or indicators (e.g., identification numbers, patient names, or record numbers) to information. In the illustrated example, the data center 310 is managed by an application server provider (“ASP”) and is located in a centralized location that can be accessed by a plurality of systems and facilities (e.g., hospitals, clinics, doctor's offices, other medical offices, and/or terminals). In some examples, the data center 310 can be spatially distant from the HIS 302, the RIS 304, and/or the PACS 306 (e.g., at General Electric® headquarters).

The example data center 310 of FIG. 3 includes a server 326, a database 328, and a record organizer 330. The server 326 receives, processes, and conveys information to and from the components of the clinical information system 300. The database 328 stores the medical information described herein and provides access thereto. The example record organizer 330 of FIG. 3 manages patient medical histories, for example. The record organizer 330 can also assist in procedure scheduling, for example.

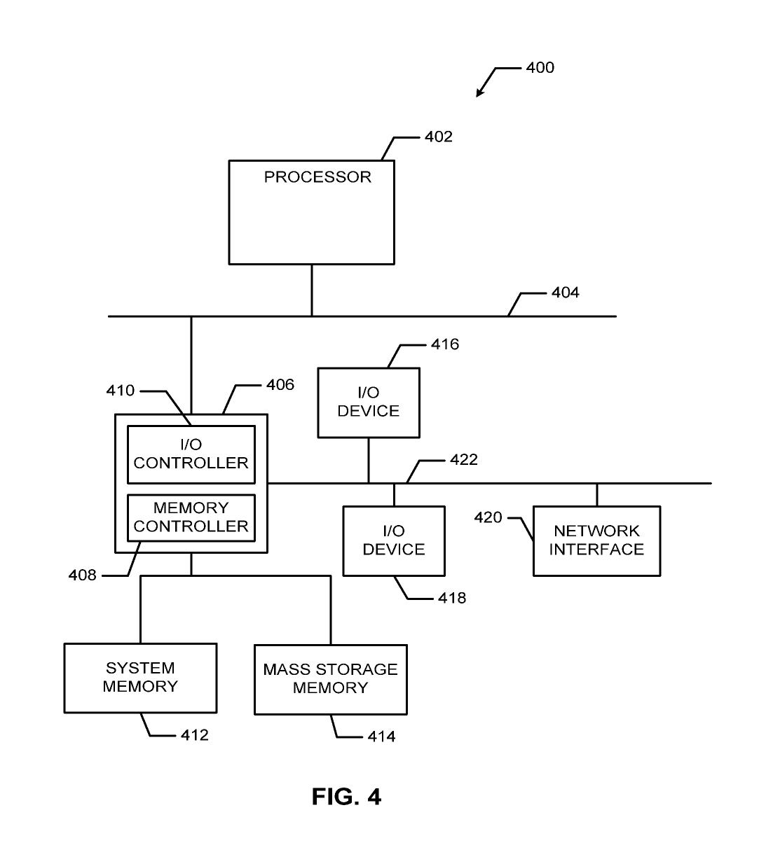

FIG. 4 is a block diagram of an example processor system 410 that can be used to implement systems, apparatus, and methods described herein. As shown in FIG. 4, the processor system 410 includes a processor 412 that is coupled to an interconnection bus 414. The processor 412 can be any suitable processor, processing unit, or microprocessor, for example. Although not shown in FIG. 4, the system 410 can be a multi-processor system and, thus, can include one or more additional processors that are identical or similar to the processor 412 and that are communicatively coupled to the interconnection bus 414. For example, “cloud” and/or “grid” based computing can be employed for three dimensional processing using Euclidian vectors and linear algebra, as described above. In certain examples, a Bayesian algorithm can be used in an evolving model combining multiple executions of multiple algorithms. As certain mappings are resolved, a probability associated with other remaining mappings changes.

The processor 412 of FIG. 4 is coupled to a chipset 418, which includes a memory controller 420 and an input/output (“I/O”) controller 422. As is well known, a chipset typically provides I/O and memory management functions as well as a plurality of general purpose and/or special purpose registers, timers, etc. that are accessible or used by one or more processors coupled to the chipset 418. The memory controller 420 performs functions that enable the processor 412 (or processors if there are multiple processors) to access a system memory 424 and a mass storage memory 425.

The system memory 424 can include any desired type of volatile and/or non-volatile memory such as, for example, static random access memory (SRAM), dynamic random access memory (DRAM), flash memory, read-only memory (ROM), etc. The mass storage memory 425 can include any desired type of mass storage device including hard disk drives, optical drives, tape storage devices, etc.

The I/O controller 422 performs functions that enable the processor 412 to communicate with peripheral input/output (“I/O”) devices 426 and 428 and a network interface 430 via an I/O bus 432. The I/O devices 426 and 428 can be any desired type of I/O device such as, for example, a keyboard, a video display or monitor, a mouse, etc. The network interface 430 can be, for example, an Ethernet device, an asynchronous transfer mode (“ATM”) device, an 802.11 device, a DSL modem, a cable modem, a cellular modem, etc., that enables the processor system 410 to communicate with another processor system.

While the memory controller 420 and the I/O controller 422 are depicted in FIG. 4 as separate blocks within the chipset 418, the functions performed by these blocks can be integrated within a single semiconductor circuit or can be implemented using two or more separate integrated circuits.

Certain examples provide systems, apparatus, and methods for automated subscription, scheduling, and review of an MDT process for a patient. Certain examples utilize a subscription-based model to keep an administrator and/or other user (e.g., attending physician) informed and to facilitate the MDT review. Certain examples facilitate an automated MDT workflow triggered by physician identification of a patient as warranting an MDT review.

Certain embodiments contemplate methods, systems and computer program products on any machine-readable media to implement functionality described above. Certain embodiments can be implemented using an existing computer processor, or by a special purpose computer processor incorporated for this or another purpose or by a hardwired and/or firmware system, for example.

Some or all of the system, apparatus, and/or article of manufacture components described above, or parts thereof, can be implemented using instructions, code, and/or other software and/or firmware, etc. stored on a machine accessible or readable medium and executable by, for example, a processor system (e.g., the example processor system 410 of FIG. 4). When any of the appended claims are read to cover a purely software and/or firmware implementation, at least one of the components is hereby expressly defined to include a tangible medium such as a memory, DVD, CD, Blu-ray disc, etc. storing the software and/or firmware.

Certain embodiments contemplate methods, systems and computer program products on any machine-readable media to implement functionality described above. Certain embodiments can be implemented using an existing computer processor, or by a special purpose computer processor incorporated for this or another purpose or by a hardwired and/or firmware system, for example.

Certain embodiments include computer-readable media for carrying or having computer-executable instructions or data structures stored thereon. Such computer-readable media can be any available media that can be accessed by a general purpose or special purpose computer or other machine with a processor. By way of example, such computer-readable media can include RAM, ROM, PROM, EPROM, EEPROM, Flash, CD-ROM, DVD, Blu-ray or other optical disk storage, magnetic disk storage or other magnetic storage devices, or any other medium which can be used to carry or store desired program code in the form of computer-executable instructions or data structures and which can be accessed by a general purpose or special purpose computer or other machine with a processor. Combinations of the above are also included within the scope of computer-readable media. Computer-executable instructions include, for example, instructions and data which cause a general purpose computer, special purpose computer, or special purpose processing machines to perform a certain function or group of functions.

Generally, computer-executable instructions include routines, programs, objects, components, data structures, etc., that perform particular tasks or implement particular abstract data types. Computer-executable instructions, associated data structures, and program modules represent examples of program code for executing steps of certain methods and systems disclosed herein. The particular sequence of such executable instructions or associated data structures represent examples of corresponding acts for implementing the functions described in such steps.

Embodiments of the present invention can be practiced in a networked environment using logical connections to one or more remote computers having processors. Logical connections can include a local area network (LAN) and a wide area network (WAN) that are presented here by way of example and not limitation. Such networking environments are commonplace in office-wide or enterprise-wide computer networks, intranets and the Internet and can use a wide variety of different communication protocols. Those skilled in the art will appreciate that such network computing environments will typically encompass many types of computer system configurations, including personal computers, hand-held devices, multi-processor systems, microprocessor-based or programmable consumer electronics, network PCs, minicomputers, mainframe computers, and the like. Embodiments of the invention can also be practiced in distributed computing environments where tasks are performed by local and remote processing devices that are linked (either by hardwired links, wireless links, or by a combination of hardwired or wireless links) through a communications network. In a distributed computing environment, program modules can be located in both local and remote memory storage devices.

While the invention has been described with reference to certain embodiments, it will be understood by those skilled in the art that various changes can be made and equivalents can be substituted without departing from the scope of the invention. In addition, many modifications can be made to adapt a particular situation or material to the teachings of the invention without departing from its scope. Therefore, it is intended that the invention not be limited to the particular embodiment disclosed, but that the invention will include all embodiments falling within the scope of the appended claims.

1. A multidisciplinary team patient referral system comprising:
a user interface to facilitate user selection of a patient for multidisciplinary review;
a subscription service to generate a subscription for a user to automatically notify the user of multidisciplinary team events related to the patient based on a parameter of the subscription; and
a multidisciplinary meeting module to facilitate a multidisciplinary team review of the patient to develop an evaluation for the patient.

2. The system of claim 1, further comprising a scheduler to facilitate scheduling of a multidisciplinary team review of the patient.

3. The system of claim 1, wherein the multidisciplinary meeting module is to provide an outcome to trigger a notification of the multidisciplinary evaluation results in conjunction with the subscription service.

4. The system of claim 1, wherein the subscription service is to create a subscription for a multidisciplinary team administrator and a subscription for a physician user, each subscription notifying a recipient of updates with respect to the patient in a multidisciplinary team workflow.

5. The system of claim 1, wherein the subscription service is to create multiple subscriptions for the user including a first subscription to track a status of the multidisciplinary team review process and a second subscription to alert the user regarding availability of the multidisciplinary team evaluation for the patient.

6. The system of claim 1, wherein the subscription service is to generate a subscription for a multidisciplinary team administrator based on a synthetic document submitted by the user, the synthetic document to generate a subscription notification upon submission by the user.

7. The system of claim 1, wherein the subscription service is to facilitate a notification for a multidisciplinary team administrator including a list of patients referred for multidisciplinary team discussion.

8. The system of claim 1, wherein the subscription service is to facilitate notification and access to documents related to the patient.

9. A tangible computer readable storage medium including executable program instructions which, when executed by a computer processor, cause the computer to implement a multidisciplinary team patient referral system, the system comprising:
a user interface to facilitate user selection of a patient for multidisciplinary review;
a subscription service to generate a subscription for a user to automatically notify the user of multidisciplinary team events related to the patient based on a parameter of the subscription; and
a multidisciplinary meeting module to facilitate a multidisciplinary team review of the patient to develop an evaluation for the patient.

10. The storage medium of claim 9, further comprising a scheduler to facilitate scheduling of a multidisciplinary team review of the patient.

11. The storage medium of claim 9, wherein the multidisciplinary meeting module is to provide an outcome to trigger a notification of the multidisciplinary evaluation results in conjunction with the subscription service.

12. The storage medium of claim 9, wherein the subscription service is to create a subscription for a multidisciplinary team administrator and a subscription for a physician user, each subscription notifying a recipient of updates with respect to the patient in a multidisciplinary team workflow.

13. The storage medium of claim 9, wherein the subscription service is to create multiple subscriptions for the user including a first subscription to track a status of the multidisciplinary team review process and a second subscription to alert the user regarding availability of the multidisciplinary team evaluation for the patient.

14. The storage medium of claim 9, wherein the subscription service is to generate a subscription for a multidisciplinary team administrator based on a synthetic document submitted by the user.

15. The storage medium of claim 9, wherein the subscription service is to facilitate a notification for a multidisciplinary team administrator including a list of patients referred for multidisciplinary team discussion.

16. The storage medium of claim 9, wherein the subscription service is to facilitate notification and access to documents related to the patient.

17. A computer-implemented method for a multidisciplinary team patient review, the method comprising:
accepting user selection of a patient for multidisciplinary review;
generating a subscription for a user to automatically notify the user of multidisciplinary team events related to the patient based on a parameter of the subscription;
automatically scheduling a multidisciplinary team review of the patient for a multidisciplinary team administrator; and
facilitating a multidisciplinary team review of the patient to develop an evaluation for the patient.

18. The method of claim 17, wherein generating a subscription further comprises creating a subscription for a multidisciplinary team administrator and a subscription for a physician user, each subscription notifying a recipient of updates with respect to the patient in a multidisciplinary team workflow.

19. The method of claim 17, wherein generating a subscription further comprises creating multiple subscriptions for the user including a first subscription to track a status of the multidisciplinary team review process and a second subscription to alert the user regarding availability of the multidisciplinary team evaluation for the patient.

20. The storage medium of claim 17, further comprising generating, via the subscription, a notification for a multidisciplinary team administrator including a list of patients referred for multidisciplinary team discussion.

21. The storage medium of claim 17, further comprising providing, via the subscription, access to documents related to the patient.
